(19) United States
(12) Patent Application Publication
(10) Pub. No.: US 2003/0112325 A1
(43) Pub. Date: Jun. 19, 2003

(54) Camera positioning system and method for eye-to-eye communication

(75) Inventors: James H. Boyden, Bellevue, WA (US); Kory D. Christensen, Kaysville, UT (US); David W. Meibos, Sandy, UT (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(73) Assignee: Digeo, Inc., Kirkland, WA

(21) Appl. No.: 10/016,675

(22) Filed: Dec. 13, 2001

(51) Int. Cl. H04N 7/14

(52) U.S. Cl. 348/14.16

(57) ABSTRACT

Eye-to-eye videoconferencing may be carried out through the use of a bendable coupling that removably disposes an image receiving device between a screen portion of a display and a person viewing the screen portion. According to one example, the image receiving device comprises a lens that conveys light into the distal end of a coherent fiber optic bundle. The light then moves through the cable to reach a camera offset from the screen portion. Alternatively, the image receiving device may be a miniature camera that provides a video signal via a video cable connected to the camera. As another alternative, the camera may be coupled to a miniature wireless transmitter. A wireless receiver offset from the screen portion may then receive the video signal and convey it to a display or communications network.

### BACKGROUND

1. Field of the Invention

The present invention relates generally to the field of video communication. More specifically, the present invention relates to a system and method for positioning a camera to enable eye-to-eye videoconferencing.

2. Description of Related Background Art

Videoconferencing is rapidly becoming a popular method of communication between remote parties who wish to approximate face-to-face contact without travel. As bandwidth limitations are ameliorated, more events such as business meetings, family discussions, and shopping may be expected to take place through videoconferencing.

Unfortunately, videoconferencing has been limited in the past by the relative positions of the camera, the display, and the person. More specifically, the camera is typically positioned above, beside, or below the screen. As a result, a person looking into the screen appears to be looking above, below, or to the side of the person with whom they are speaking. Eye contact is never actually made because neither party looks at the camera; rather, each person looks at his or her own screen. Consequently, both parties perceive that true face-to-face communication is not occurring.

A lack of eye contact has a definite psychological impact. More specifically, if eye contact is not made, each party may misinterpret comments made by the other party; misunderstandings and mutual distrust may result. The communicating parties may find themselves unable to adequately understand each other, and may even prematurely terminate the videoconferencing session out of frustration. Hence, poor quality communications are not only problematic for the communicating parties, but also for the entity that provides the communication channel. To the extent that access to the channel is metered, longer videoconferencing sessions will provide greater profits.

Some devices have been made in an attempt to more closely simulate eye-to-eye communication. Such devices may involve, for example, the use of complex and specialized displays with advanced optical and projection equipment. Unfortunately, most consumers would wish to communicate via conventional, inexpensive personal computer or entertainment hardware such as “webcams” and televisions.

Accordingly, what is needed is a system and method for obtaining an image of a person from along the person's eye-level when the person is looking at the image of a second person on a screen. Preferably, such a system should lend the impression of eye-to-eye communication without unduly burdening other aspects of the videoconferencing process or distracting the communicating party with camera attachments that move excessively or obstruct the screen more than necessary. Additionally, such a system and method should preferably be adaptable to existing consumer hardware.

### BRIEF DESCRIPTION OF THE DRAWINGS

Non-exhaustive embodiments of the invention are described with reference to the figures, in which:

FIG. 1 is a perspective view of one embodiment of an apparatus for obtaining a video signal from a position proximate to an eye-level of a person viewing a display;

FIG. 2 is a side elevation, section view of the apparatus of FIG. 1;

FIG. 3 is a side elevation, section view of an alternative embodiment of an apparatus for obtaining a video signal from a position proximate to an eye-level of a person viewing a display; and

FIG. 4 is a side elevation, section view of another alternative embodiment of an apparatus for obtaining a video signal from a position proximate to an eye-level of a person viewing a display.

### DETAILED DESCRIPTION OF THE PREFERRED EMBODIMENTS

The present invention solves the foregoing problems and disadvantages by providing an apparatus for obtaining a video signal from a position proximate to an eye-level of a person viewing a display. In conjunction with the apparatus, a method for positioning the camera is also provided. The apparatus and method may be configured in a wide variety of ways to suit specific videoconferencing situations.

In one implementation, the apparatus may include a camera and a bendable coupling with a proximal end and a distal end. The camera may be coupled to the distal end. The bendable coupling may be selectively disposed such that the camera is positioned between a viewer and a screen portion of the display. The viewer may thus use the bendable coupling to move the camera to a deployed disposition, in which the camera is close to the level at which the viewer looks at the display. Similarly, the bendable coupling may be used to move the camera to a retracted disposition to avoid obscuring the display during normal use.

Of course, the actual location of the camera will vary depending on the viewer. For some viewers, moving the camera to a deployed disposition will require the camera to be positioned at the center of the display. For other viewers, however, the camera may need to be positioned in other areas of the display.

The bendable coupling may be made stiff enough to independently support the camera at a plurality of positions along the circumference of a generally hemispherical positioning zone. The bendable coupling may thus take the form of a length of wire or twine. The bendable coupling may be anchored to the display via a base coupled to the proximal end of the bendable coupling and to the display, at an off-screen location such as a top side of the display.

In one embodiment, the image receiving device comprises a distal lens positioned to direct light into a distal end of a coherent fiber optic bundle coupled to the bendable coupling. A proximal end of the coherent fiber optic bundle may then direct the light into a camera, which may be integral with the base. The camera then resolves the light into an electric signal that can be conveyed to a display device, communication network, or the like, via a video cable.

According to another embodiment, the image receiving device comprises a compact camera. A video cable may then extend from the camera along the bendable coupling. The video cable may then convey the video signal directly to the display device or communication network; if desired, the video cable may be coupled to the base.

According to yet another embodiment, the image receiving device comprises a compact camera. However, no cable extends along the bendable coupling. Rather, a wireless transmitter is positioned at the camera. The wireless transmitter transmits the video signal in a wireless form. A wireless receiver is then positioned off-screen, for example, at the base. A video cable is then connected to the wireless receiver to convey the video signal to the communication network or display device.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of couplings, attachment devices, camera positions, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

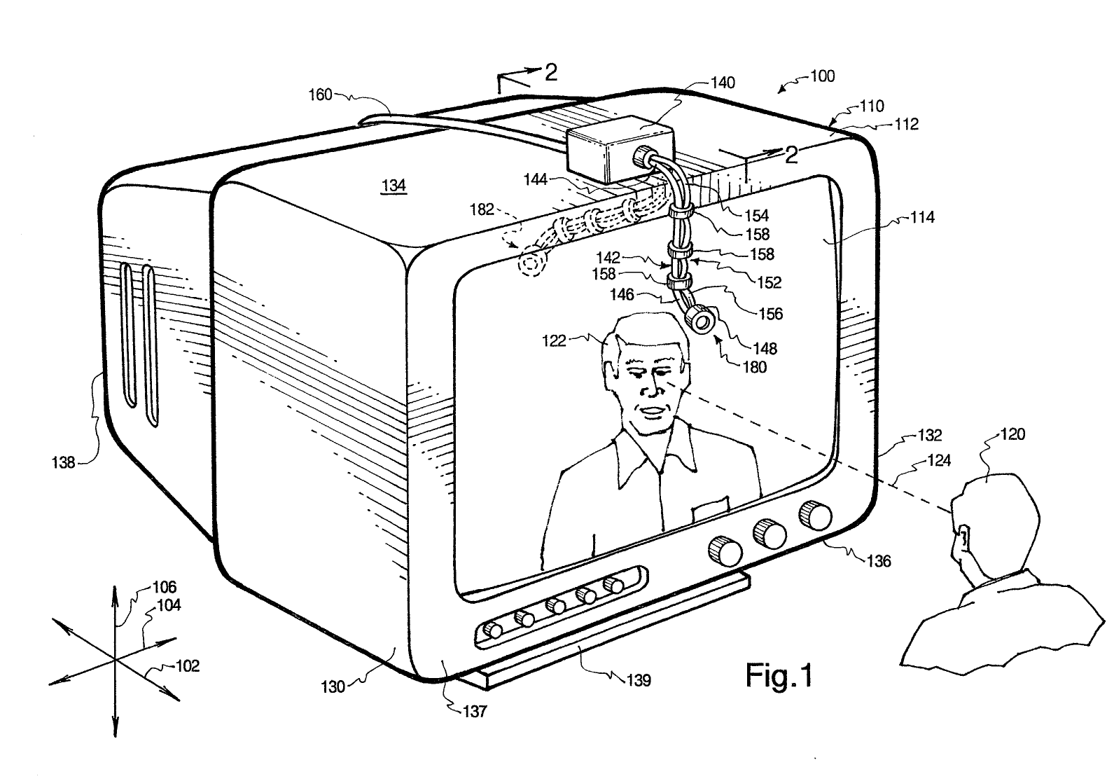

Referring to FIG. 1, a perspective view shows one embodiment of an apparatus 100 for receiving light for conversion to a video signal from a position proximate to an eye-level of a person viewing a display. The apparatus 100 may have a longitudinal direction 102, a lateral direction 104, and a transverse direction 106.

A display 110 may be of any known type, such as a cathode ray tube (CRT) screen, a liquid crystal display (LCD), liquid plasma display, analog or digital projection, or the like. Advantageously, the display 110 may be a device commonly available to consumers, such as a computer monitor or television. The display 110 may have a housing 112 that contains the internal components of the display, and a screen portion 114 on which images are displayed.

The display 110 may be used by a person 120 to conduct videoconferencing with a second person, whose image 122 is shown on the screen portion 114 of the display 110. The person 120 may be expected to look at the image 122, so that the person 120 is looking along an eye-level 124, as shown by a dashed line in FIG. 1. The person 120 may, for example, look approximately at the eyes of the person whose image 122 is shown on the screen portion 114.

The display 110 may have a left side 130, a right side 132, a top side 134, a bottom side 136, a front side 137, and a back side 138. Furthermore, the display 110 may have a platform 139 that supports the weight of the display 110. The platform 139 may be rigid, or may permit swiveling or tilting of the display 110. Of course, the display 110 may also operate without a platform 139.

The apparatus 100 of FIG. 1 has a base 140. The base 140 is shown coupled to the top side 134 of the display 110; however, the base 140 may alternatively be coupled to a different portion of the display 110, or to another stationary object close to the display 110.

The apparatus 100 also has a bendable coupling 142, which has a proximal end 144 coupled to the base 140 and a distal end 146 that can be moved relatively freely. The bendable coupling 142 may have a stiffness selected such that the bendable coupling 142 can maintain a plurality of different shapes. For example, the bendable coupling 142 may be formed of one or more pieces of wire, twine, shape-holding plastic, shape-holding elastomer, or any other suitable material. By deforming the bendable coupling 142, the distal end 146 can be positioned at a variety of locations along or within a circumference of a generally hemispherical positioning zone, which will be shown and described in greater detail subsequently.

An image receiving device 148 is coupled to the distal end 146 of the bendable coupling 142. The image receiving device 148 receives light from along the eye-level 124. According to certain configurations, the image receiving device 148 simply conveys the light onward; in other configurations, the image receiving device 148 converts the light into an electric signal. Various configurations of the image receiving device 148 will be shown and described subsequently.

According to the configuration of FIG. 1, the image receiving device 148 simply receives light and conveys it into a coherent fiber optic bundle 152. The coherent fiber optic bundle 152 extends along the bendable coupling 142, and has a proximal end 154 coupled to the base 140 and a distal end 156 coupled to the image receiving device 148. The coherent fiber optic bundle 152 may be coupled to the bendable coupling 142 along its length in a profile-minimizing manner. For example, a plurality of rings 158 or the like may be used to constrain the coherent fiber optic bundle 152 to lie along the bendable coupling 142. Of course, other attachment devices such as tubing, clips, cords, adhesives, or the like may also be used.

The proximal end 154 of the coherent fiber optic bundle 152 conducts light from the image receiving device 148 into the base 140. The base 140 thus comprises an analog or digital camera that receives the light and resolves it into an electrical signal formatted as video. The video signal may be conveyed further, e.g., to an image processor, display device, storage device, communication device, or the like via a video cable 160.

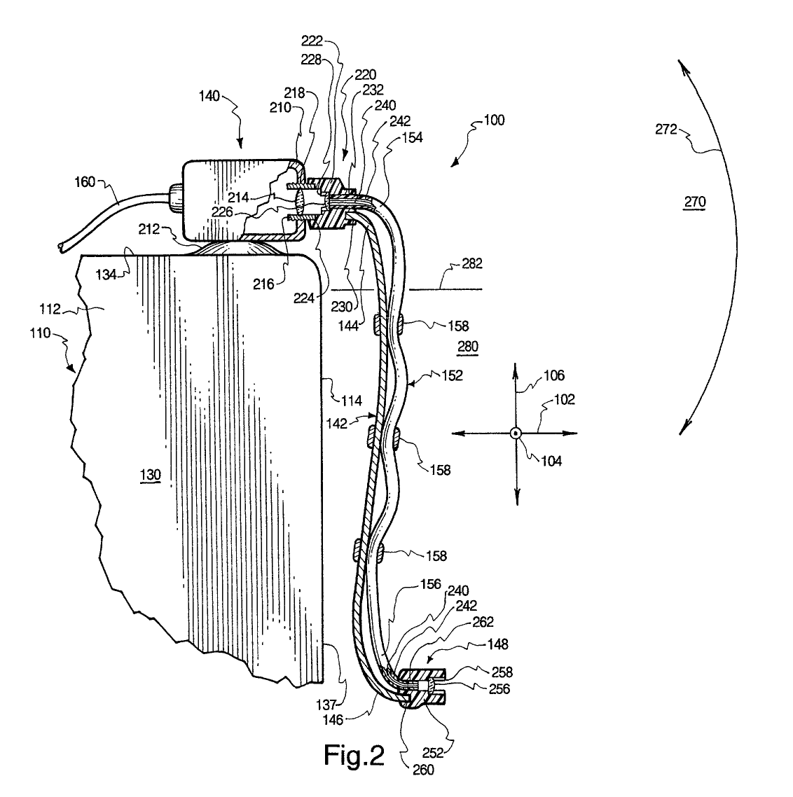

Referring to FIG. 2, a side elevation, section view is shown of the apparatus 100 of FIG. 1. As shown, the base 140 has a housing 210 that contains camera circuitry. The housing 210 is affixed to an attachment feature 212 that permanently or removably attaches the housing 210 to the display 110. As mentioned previously, the housing 210 could also be coupled to another stationary object in the vicinity of the display 110, such as a table, computer case, shelf, or the like. In FIG. 2, the attachment feature 212 is coupled to the top side 134 of the display 110.

The attachment feature 212 may take the form of a suction cup 212, as shown. Alternatively, attachment systems such as threaded fasteners, rivets, magnets, hook and loop systems, and the like may be used. If desired, the display 110 may have features such as holes, slots, mounting protrusions, or the like to mate with complementary features of the base 140. Such features may provide for easy attachment, but may detract from the ability of the person 120 to retrofit the apparatus 100 to any existing display 110.

In order to receive and process light, the base 140 may have a camera lens 214 held within the housing 210 by a camera lens retainer 216. The camera lens retainer 216 may, for example, have an interface, such as threads 218, with the housing 210 that permits removal of the camera lens retainer 216 from the housing 210. The housing 210 may contain conventional analog video capture hardware or digital video capture hardware such as a charge coupled device (CCD) sensor, complementary metal oxide semiconductor (CMOS) sensor, or other sensors that convert electromagnetic energy into readable image signals. Such hardware is known in the art and therefore is not shown in FIG. 2.

A socket 220 may be coupled to the camera lens retainer 216. The socket 220 may have a housing 222 coupled to the lens retainer 216 through the use of an interface, such as the threads 224 depicted in FIG. 2. A proximal lens 226 may be coupled to the housing 222 through the use of a proximal lens retainer 228, for example, threadably engaged within the housing 222.

The configuration of the camera lens 214 and the proximal lens 226 is provided by way of example. Those of skill in the art will recognize that any structure or assembly that conveys light from the proximal end 154 of the coherent fiber optic bundle 152 into the base 140 in such a manner that the light can be converted to a clear video signal may be used in place of the camera lens 214 and the proximal lens 226.

Other lens configurations may be used, including compound lens assemblies of the type commonly used for photography. Alternatively, in certain embodiments, no lenses may be used at the proximal end 154. Rather, light from the proximal end 154 may impinge directly on a CCD or other digital or analog sensor to provide the video signal.

The housing 222 of the socket 220 may have a coupling aperture 230 that receives and retains the bendable coupling 142 and a bundle aperture 232 that retains the proximal end 154 of the coherent fiber optic bundle 152. The bundle aperture 232 is aligned with the proximal lens 226. The coherent fiber optic bundle 152 may consist of a bundle of optical grade fibers 240 wrapped within a sheath 242. A cladding layer (not shown) may also be included.

The term “coherent” refers to the ability of the coherent fiber optic bundle 152 to convey not just light, but an image. Thus, a coherent fiber optic bundle typically has fibers that begin and end in the same position within the planes that terminate the bundle. According to selected embodiments, the fibers may not begin and end at the same positions, but coherency may still be obtained through the use of a pixel mapping that utilizes a lookup table or a similar data structure to rearrange pixels received into their proper positions.

Consequently, the coherent fiber optic bundle 152 either has fibers that begin and end at the same positions, or includes some suitable pixel mapping mechanism to correct any positional differences that exist between the starting and ending positions of the fibers. The fibers 240 terminate at the proximal end 154 at a displacement from the proximal lens 226 selected to convey a focused image through the proximal lens 226.

The distal end 156 of the coherent fiber optic bundle 152 is coupled to the image receiving device 148. In the embodiment of FIG. 2, the image receiving device 148 has a housing 252 that retains a distal lens 256, for example, through the use of a distal lens retainer 258. Like the proximal lens 226, the distal lens 256 is positioned at a displacement from the end of the fibers 240 of the distal end 156 selected to convey a clear image from the distal lens 256 into the fibers 240.

The distal lens 256 is depicted in FIG. 2 simply by way of example. Those of skill in the art will recognize that, like the proximal lens 226 and the camera lens 214, the distal lens 256 may be replaced with a plurality of alternative structures or assemblies. For example, a wide angle compound lens assembly may be used to gather light from a comparatively wide field-of-view to account for the fact that the person 120 may communicate from a position comparatively close to the display 110. Alternatively, a variable zoom lens may be used to manually or automatically adjust the size of the field-of-view to compensate for motion of the person 120 toward or away from the display 110.

As yet another alternative, the distal lens 256 may be omitted entirely. The distal end 156 may be specially configured to receive light directly without the use of a lens.

Like the socket 220, the image receiving device has a coupling aperture that retains the distal end 146 of the bendable coupling 142 and a bundle aperture 262 that retains the distal end 156 of the coherent fiber optic bundle 152. The distal end 156 of the bendable coupling 142 may simply be bent in the direction desired by the person 120. Hence, the person 120 need not have his or her head directly aligned with the image receiving device 148 in the lateral direction 104 or the transverse direction 106. The person 120 may also bend the distal end 156 to utilize the image receiving device 148 for videoconferencing when the image receiving device 148 is positioned off the screen portion 114.

As shown, the image receiving device 148 is capable of moving within a positioning zone 270 within a generally hemispherical shape, bounded by the arrow 272 depicted in FIG. 2. The bendable coupling 142 may have a stiffness sufficient to independently hold the image receiving device 148 in place at any position within the positioning zone 270.

A deployment zone 280 is a subset of the positioning zone 270 that projects outward from the screen portion 114 in the transverse direction 102. The deployment zone 280 is separated from the remainder of the positioning zone 270 by a plane, an edge view of which is shown in FIG. 2 as line 282 extending longitudinally from the junction of the screen portion 114 with the bezel of the display 110, i.e., the portion of the housing 112 that frames the screen portion 114. Hence, the deployment zone 280 is beside the screen portion 114, but not the bezel.

Any position of the image receiving device 148 that lies within the deployment zone 280 may be considered a deployed disposition. By the same token, any position of the image receiving device 148 that lies outside the deployment zone 280 may be considered a retracted disposition. Of course, the bendable coupling 142 may also be deformed such that the image receiving device 148 is disposed over the top side 134 of the display 110.

Additionally, the image receiving device 148 may have features that automatically deactivate the image receiving device 148 when the image receiving device 148 is removed from the proximity of the screen portion 114 to protect the privacy of the person 120. For example, the image receiving device 148 may have a mechanical switch, proximity sensor, light sensor, or the like (not shown) abutting the screen portion 114. When the image receiving device 148 is removed from the proximity of the screen portion 114, the switch or sensor may stop the image receiving device 148 from transmitting video data.

If desired, the image receiving device 148 may include one or more light emitting diodes (LED's) that provide a visual indication of whether the image receiving device 148 is operating. Alternatively, the image receiving device 148 may be equipped with a mechanical shutter that can be manually closed or actuated through the use of a switch or sensor to assure the person 120 that the image receiving device 148 is not receiving any image.

Furthermore, if desired, the image receiving device 148 may have an optical sensor (not shown) facing the screen portion 114 to enable the person 120 to control the image receiving device 148. For example, through the use of specialized software, hardware, or firmware, commands to control functions such as panning, tilting, zooming, contrast adjustment, and brightness adjustment could be translated into patterns of flashes, color changes, or the like. The patterns may be displayed on the portion of the screen portion 114 behind the image receiving device 148. The patterns may be read by the sensor of the image receiving device 148, and the image receiving device 148 may then adjust its operation to carry out the user command.

The bendable coupling 142 and the coherent fiber optic bundle 152 may advantageously be made as thin as possible in the lateral direction 104 to avoid obscuring the image 122 any more than necessary. For example, the coherent fiber optic bundle 152 and the bendable coupling 142 may be only a centimeter thick in the lateral direction 104, or less. For ease of illustration, the coherent fiber optic bundle 152 and the bendable coupling 142 are depicted in FIG. 1 as being thicker. Of course, the precise thickness of the bendable coupling 142 and the coherent fiber optic bundle 152 are not crucial to the invention. The bendable coupling 142 may also be made translucent, if desired, to further reduce obstruction of the screen portion 114.

As another option, the bendable coupling 142 may be omitted entirely in favor of a different type of support for the coherent fiber optic bundle 152. Struts, cords, adhesives, mechanical fasteners, and the like may be used to movably position the distal end 156 of the coherent fiber optic bundle 152 and the image receiving device 148.

The person 120 may use the apparatus 100 to position the image receiving device 148 at a deployed disposition 180 (see FIG. 1), which may be positioned proximate the eyes of the image 122 on the screen portion 114. When the display 110 is in use for purposes other than videoconferencing, such as computer or television use, the image receiving device 148 may be moved to a retracted disposition 182 (see FIG. 1) in which the image receiving device 148, the bendable coupling 142, and the coherent fiber optic bundle 152 do not significantly overlap the screen portion 114.

In FIG. 1, the retracted disposition 182 is shown in phantom lines over the top of the screen portion 114. The image receiving device 148 could also be moved to many other positions to avoid obstructing use of the display 110.

Displacing the image receiving device 148 slightly from the eyes of the image 122 provides the realistic semblance of eye-to-eye communication for the person whose image 122 is displayed on the screen portion 114, i.e., the person with whom the person 120 using the apparatus 100 is communicating. For example, the image receiving device 148 may be disposed slightly above and/or to one side of the head of the image 122, as shown in FIG. 1. In alternate embodiments, the image receiving device 148 may be disposed slightly below or simply to the left or right of the head of the image 122.

Thus, the image receiving device 148 need not be disposed precisely along the eye-level 124. If the image receiving device 148 is simply positioned proximate, or close to, the eye-level 124, the person whose image 122 is shown on the screen portion 114 may not notice that the person 120 is looking slightly up or down, or to one side. Thus, if both parties involved in videoconferencing are using an apparatus 100, slight displacement of the image receiving device 148 from the eye-level 124 may provide realistic eye-to-eye communication for both parties simultaneously.

However, in accordance with the present invention, the image receiving device 148 may be positioned precisely along the eye-level 124. Thus, depending on the geometry of the image receiving device 148, the coherent fiber optic bundle 152, and the bendable coupling 142, the eyes of the person whose image 122 is displayed may be blocked by the image receiving device 148, the coherent fiber optic bundle 152, and the bendable coupling 142.

Clearly, the image receiving device 148 need not be disposed in the center of the screen portion 114. For the reasons described above, it may be desirable to position the image receiving device 148 off-center. Furthermore, the image 122 may not be centered, but may be within a window with any size or location on the screen portion 114. Hence, motion of the image receiving device 148 in the lateral 104 and transverse directions 106 may be desirable so that the position of the image receiving device 148 can be adapted to suit the size and position of the image 122.

If the coherent fiber optic bundle 152 includes multiple fibers, the apparatus 100 or a connected post-processing unit (not shown) may process the video signal to remove artifacts resulting from the spaces between fibers. More specifically, the use of multiple fibers may produce an image with darkened web-like regions introduced by the separation of the fibers from each other.

The image quality may thus be enhanced through the use of techniques such as interpolation and downsampling. More specifically, interpolation may be used to estimate and apply the appropriate color for darkened regions. Through downsampling, if the darkened regions are thin, they may be eliminated entirely by virtue of the process by which the video image is reduced in size. Such processing may be carried out through the use of hardware, software, or firmware that operates in the base 140 or in any suitable post-processing device.

The apparatus 100 may be sold as a kit that includes the base 140, the bendable coupling 142, the image receiving device 148, the coherent fiber optic bundle 152, and/or the video cable 160. The person 120 may use the suction cup 212 to attach the base 140 to the display 110. The person 120 may then bend the bendable coupling 142 to place the image receiving device 148 in the proper position within the deployment zone 280, i.e., at the deployed disposition 180. Then, the person 120 may further bend the bendable coupling 142 to adjust the orientation of the image receiving device 148 so that the image receiving device 148 receives light generally from along the eye level 124.

When videoconferencing is no longer occurring, the person 120 may simply bend the bendable coupling 142 to remove the image receiving device 148 from the deployment zone 280. The image receiving device 148 may thus be disposed in the retracted disposition 182 to avoid inhibiting viewing of the screen portion 114.

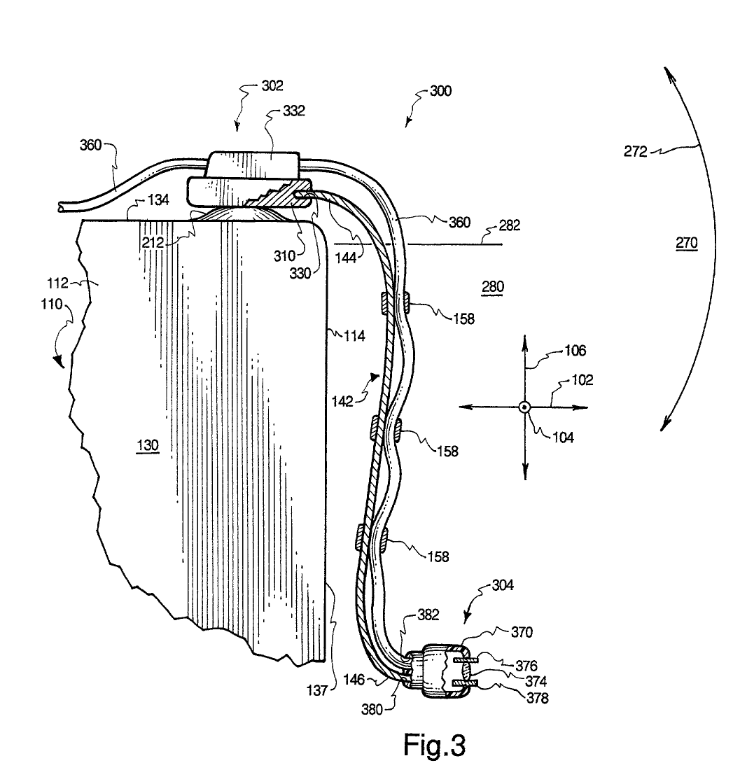

In certain embodiments, it may be desirable to utilize a simplified configuration in which fiber optics are not required. One example of such a configuration is shown by way of example in FIG. 3.

Referring to FIG. 3, a side elevation, section view is shown of an alternative embodiment of an apparatus 300 for receiving light for conversion to a video signal from a position proximate to an eye-level of a person viewing a display. As with the previous embodiment, the apparatus 300 has a base 302 attached to the top side 134 of the display 110.

An image receiving device 304 is coupled to the base 302 via a bendable coupling 142 similar to that shown and described in connection with the previous embodiment. However, in the apparatus 300, the image receiving device 304 comprises a camera 304, while the base 302 may simply be a platform 302 that contains no electrical circuitry, but simply anchors the proximal end 144 of the bendable coupling 142.

More specifically, the base 302 may have a housing 310 attached to the display 110 through the use of an attachment feature 212 such as the suction cup 212 depicted in FIG. 3. The base 302 may have a coupling aperture 330 that grips the proximal end 144 of the bendable coupling 142. If desired, a video cable holder 332 may be attached to the base 302 to hold a video cable 360 extending from the camera 304, along the bendable coupling 142, along the base 302, and to a display device, communication subsystem, or the like.

The camera 304 may have a housing 370 that retains a camera lens 374, through which light passes to reach the interior of the camera 304. As with the base 140, the housing 370 of the camera 304 may include conventional analog video capture hardware or digital video capture hardware. The camera lens 374 may be held in place by a camera lens retainer 376 that is removably coupled to the housing 370 through the use of an interface, such as threads 378.

As with previous embodiments, the camera lens 374 is shown simply by way of example, and may be replaced with alternative structures. For example, wide angle compound lenses, variable zoom lenses, or the like may be used to account for various positions of the person 120 with respect to the display 110.

If desired, the camera 304 may be a miniaturized digital camera of a type known in the art to minimize obstruction of the screen portion 114. The camera 304 may receive power via electrical wiring disposed in conjunction with the video cable 360. The camera 304 may alternatively be powered internally through the use of batteries or the like.

The housing 370 may have a coupling aperture 380 that receives and retains the distal end 146 of the bendable coupling 142 and a video bundle aperture 382 from which the video cable 360 extends. The video cable 360 extends from the video bundle aperture 382 along the bendable coupling 142. The video cable 360 may be held in place against the bendable coupling 142 through the use of rings 158, in a manner similar to the coherent fiber optic bundle 152 of the previous embodiment. The video cable 360 may pass through the video cable holder 332, and then to a display device or communications network.

The apparatus 300 may operate in a manner similar to that described in connection with the previous embodiment. More specifically, the user may bend the bendable coupling 142 to position the camera 304 within the positioning zone 270. The user may move the camera 304 into the deployment zone 280 to a deployed disposition 180 or out of the deployment zone 280 to a retracted disposition 182.

The camera 304 may receive light from along the eye level 124 and convert the light into a video signal to be conveyed along the video cable 360. Hence, no fiber optics are required to convey light to a remote camera. Thus, the apparatus 300 may be somewhat simpler than the previous embodiment. However, the camera 304 may be somewhat bulkier, and may thus obstruct the screen portion 114 somewhat more than the image receiving device 148 of FIGS. 1 and 2.

Like the previous embodiment, the apparatus 300 may be produced and sold as a kit that can be retrofitted to an existing display 110. If desired, such a kit may exclude the camera 304, so that the base 302 and the bendable coupling 142 could be used in conjunction with one or more types of common commercial webcams. Thus, the distal end 146 of the bendable coupling 142 may have some form of attachment mechanism made to receive a webcam. Suction cups, threaded fasteners, magnets, hook and loop systems, and the like could be used to attach the distal end 146 to the webcam. The video cable 360 may then be the output cable from the webcam.

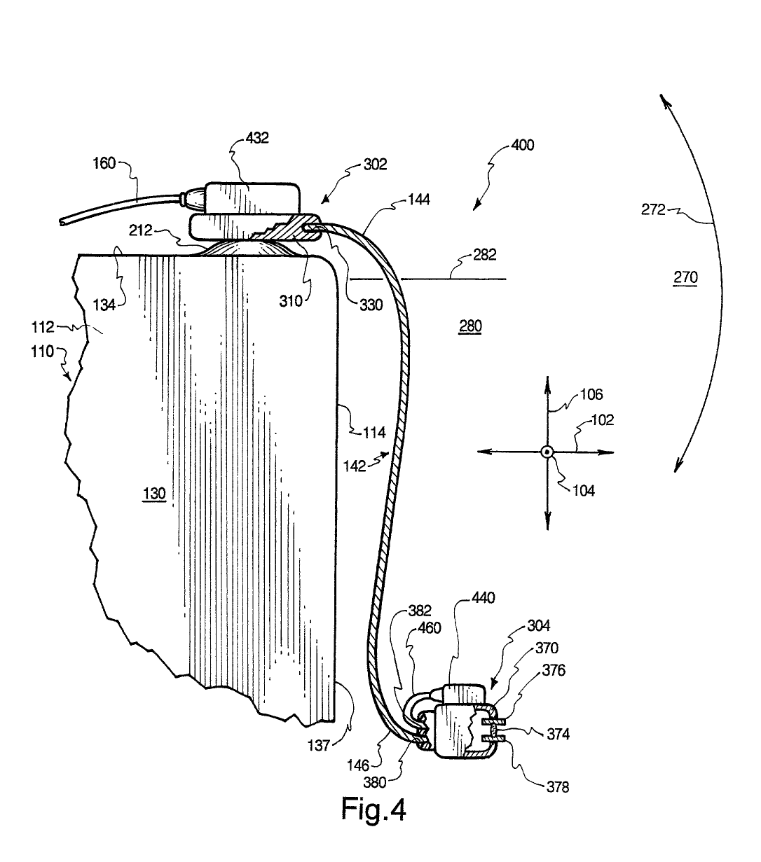

In other embodiments, it may be desirable to avoid the presence of any cable disposed along the bendable coupling 142. One such embodiment is depicted by way of example in FIG. 4.

Referring to FIG. 4, a side elevation, section view is shown of another alternative embodiment of an apparatus 400 for receiving light for conversion to a video signal from a position proximate to an eye-level of a person viewing a display. The apparatus 400 is configured in a manner similar to that of the previous embodiment. More specifically, the apparatus 400 may have a base 302 in the form of a platform 302, an image receiving device 304 in the form of a camera 304, and a bendable coupling 142 that connects the platform 302 with the camera 304.

However, no fiber optic or electric cable is disposed along the bendable coupling 142. Rather, a wireless receiver 432 is disposed at some location outside the deployment zone 280. The wireless receiver 432 may be attached to the base 302, if desired. The video cable 160 is not coupled to the camera 304, but to the wireless receiver 432.

The camera 304 is connected to a wireless transmitter 440 via a transfer cable 460. Of course, the video signal may be transmitted through other mechanisms besides the transfer cable 460. For example, the wireless transmitter 440 may be disposed within the housing 370 of the camera 304; the wireless transmitter 440 may then receive the video signal via transmission through analog circuitry or a digital bus.

The wireless transmitter 440 may, for example, transmit video data through any suitable protocol, such as IEEE 802.11, IEEE 802.11a, IEEE 802.11 b, Bluetooth, HiperLan, and HiperLan/2. The wireless transmitter 440 may also transmit an analog video signal, for example, through frequency or amplitude modulation of radio waves. If desired, the camera 304 and the wireless transmitter 440 may be configured in a manner similar to the XCam2™ wireless camera manufactured by X10 Wireless Technologies, Inc. of Seattle, Wash. The camera 304 and/or the wireless transmitter 440 may have an internal power source such as one or more batteries.

When the camera 304 receives light, a video signal is produced and conveyed to the wireless transmitter 440. The wireless transmitter 440 then broadcasts the video signal. The wireless receiver 432 receives the video signal and conveys it to a connected display, communication system, or the like via the video cable 160.

The apparatus 400 may serve to further minimize obstruction of the screen portion 114 by eliminating cables that extend between the camera 304 and the platform 302. Eye-to-eye video communication may thus be achieved with little distraction or impediment.

Based on the foregoing, the present invention offers a number of advantages that are not available in conventional approaches. A person can relatively easily retrofit an apparatus according to the invention to existing hardware such as a television or computer monitor. Furthermore, a person can relatively easily position the camera proximate their eye-level or in a retracted disposition to avoid interfering with other uses of the display. Thus, during videoconferencing, a person can receive the impression that the person with whom they are communicating is looking them directly in the eye.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. An apparatus for receiving light for conversion to a video signal from a position proximate to an eye-level of a person viewing a display, the apparatus comprising:
a base;
an image receiving device that collects light; and
a bendable coupling having a proximal end coupled to the base and a distal end coupled to the image receiving device, the bendable coupling having a stiffness selected to support the distal end at a plurality of positions along and within a circumference of a generally hemispherical positioning zone, wherein the bendable coupling is deformable into a deployed disposition in which the distal end is positioned within a deployment zone beside the screen portion.

2. The apparatus of claim 1, wherein the bendable coupling is further deformable into a retracted disposition in which the distal end is not positioned within the deployment zone.

3. The apparatus of claim 1, further comprising:
a coherent fiber optic bundle connected to convey the light from the image receiving device to the base.

4. The apparatus of claim 3, wherein the image receiving device comprises a distal lens positioned to direct the light into the coherent fiber optic bundle.

5. The apparatus of claim 4, wherein the base comprises a camera that receives the light from the coherent fiber optic bundle and processes the light to provide the video signal.

6. The apparatus of claim 5, further comprising:
a proximal lens positioned to direct the light from the coherent fiber optic bundle into the camera.

7. The apparatus of claim 1, wherein the image receiving device comprises a camera that processes the light to generate the video signal.

8. The apparatus of claim 7, further comprising:
electric wiring connected to convey the video signal from the camera to the base.

9. The apparatus of claim 1, wherein the image receiving device comprises a camera that processes the light to provide the video signal, the apparatus further comprising:
a wireless transmitter positioned at the distal end of the bendable coupling to receive the video signal from the camera and transmit the video signal.

10. The apparatus of claim 9, wherein the base comprises a wireless receiver that receives the video signal from the wireless transmitter.

11. The apparatus of claim 1, wherein the bendable coupling is translucent.

12. The apparatus of claim 1, wherein the base is coupled to the display.

13. An apparatus for receiving light for conversion to a video signal from a position proximate to an eye-level of a person viewing a display, the apparatus comprising:
a camera; and
a coherent fiber optic bundle that conveys light from a distal end to a proximal end, wherein the distal end is positioned within a deployment zone beside a screen portion of the display and the proximal end is positioned to direct the light into the camera.

14. The apparatus of claim 13, further comprising:
a bendable coupling having a proximal end and a distal end that supports the distal end of the coherent fiber optic bundle.

15. The apparatus of claim 14, wherein the proximal end of the bendable coupling is coupled at a location outside the deployment zone.

16. The apparatus of claim 15, wherein the bendable coupling is deformable to move between a deployed disposition in which the distal end of the bendable coupling is positioned within the deployment zone, and a retracted disposition in which the distal end of the bendable coupling is not positioned within the deployment zone.

17. The apparatus of claim 15, further comprising:
a base coupled to the proximal end of the bendable coupling and to the display.

18. The apparatus of claim 15, wherein the camera comprises a base coupled to the proximal end of the bendable coupling and to the display.

19. The apparatus of claim 13, further comprising:
a distal lens positioned to direct the light into the distal end of the coherent fiber optic bundle.

20. The apparatus of claim 19, further comprising:
a proximal lens positioned to direct the light from the proximal end of the coherent fiber optic bundle into the camera.

21. A method for receiving light for conversion to a video signal from a position proximate to an eye-level of a person viewing a display with an apparatus comprising a base, an image receiving device, and a bendable coupling having a proximal end coupled to the base and a distal end coupled to the image receiving device, the method comprising:
bending the bendable coupling to position the image receiving device proximate to an eye-level of a person viewing the display;
orienting the image receiving device to receive light from along the eye-level;
receiving light through the image receiving device; and
processing the light to generate a video signal.

22. The method of claim 21, wherein bending the bendable coupling comprises moving the bendable coupling from a retracted disposition in which the distal end is not positioned within a deployment zone beside a screen portion of the display to a deployed disposition in which the distal end is positioned within the deployment zone.

23. The method of claim 21, further comprising:
conveying the light from the distal end to the proximal end via a coherent fiber optic bundle.

24. The method of claim 23, wherein receiving the light comprises capturing the light via a distal lens positioned to direct the light into the coherent fiber optic bundle.

25. The method of claim 24, wherein the base comprises a camera that generates the video signal, the method further comprising:
conveying the light from the proximal end to the camera.

26. The method of claim 25, wherein conveying the light from the proximal end to the camera comprises positioning a proximal lens to direct the light from the coherent fiber optic bundle into the camera.

27. The method of claim 21, wherein the image receiving device comprises a camera that processes the light.

28. The method of claim 27, further comprising:
conveying the video signal from the camera to the proximal end via electrical wiring extending from the camera to the proximal end.

29. The method of claim 21, wherein the image receiving device comprises a camera that processes the light, the method further comprising:
wirelessly transmitting the video signal from the proximal end.

30. The method of claim 29, further comprising:
wirelessly receiving the video signal in the base.

31. The method of claim 21, further comprising permitting viewing of a screen portion of the display through the bendable coupling via translucency of the bendable coupling.

32. The method of claim 21, further comprising:
coupling the base to the display.

33. A method for receiving light for conversion to a video signal from a position proximate to an eye-level of a person viewing a display with an apparatus comprising a camera and a coherent fiber optic bundle that conveys light from a distal end to a proximal end, the method comprising:
receiving light in the distal end of the coherent fiber optic bundle from along an eye-level of a person viewing the display screen;
conveying the light through the coherent fiber optic bundle from the distal end to the proximal end; and
processing the light in the camera to generate a video signal.

34. The method of claim 33, further comprising:
bending a bendable coupling to position the distal end proximate to an eye-level of a person viewing the display; and
orienting the distal end to receive light from along the eye-level.

35. The method of claim 34, wherein the bendable coupling has a proximal end coupled at a location outside a deployment zone beside a screen portion of the display.

36. The method of claim 35, wherein bending the bendable coupling comprises moving the bendable coupling from a retracted disposition in which the distal end is not positioned within the deployment zone to a deployed disposition in which the distal end is positioned within the deployment zone.

37. The method of claim 35, further comprising:
coupling a base to the proximal end of the bendable coupling and to the display.

38. The method of claim 35, further comprising:
coupling the camera to the proximal end of the bendable coupling and to the display to form a base.

39. The method of claim 33, further comprising:
positioning a distal lens to direct the light into the distal end of the coherent fiber optic bundle.

40. The method of claim 39, further comprising:
positioning a proximal lens to direct the light from the proximal end of the coherent fiber optic bundle into the camera.

41. An apparatus for receiving light for conversion to a video signal from a position proximate to an eye-level of a person viewing a display, the apparatus comprising:
a base;
an image receiving means that collects light; and
a bendable coupling means having a proximal end coupled to the base and a distal end coupled to the image receiving means, the bendable coupling means having a stiffness selected to support the distal end at a plurality of positions along and within a circumference of a generally hemispherical positioning zone, wherein the bendable coupling means is deformable into a deployed disposition in which the distal end is positioned within a deployment zone beside the screen portion.
